(19) United States
(12) Patent Application Publication
(10) Pub. No.: US 2026/0048531 A1
(43) Pub. Date: Feb. 19, 2026

(54) TOOTHED DISC CLEANER

(71) Applicant: HydroDyn Recycling GmbH, Hamburg (DE)

(72) Inventors: Michael Hofmann, Hamburg (DE); Christian Borowitz, Schwerin (DE); Marcel Klug, Ludwigslust (DE)

(73) Assignee: HydroDyn Recycling GmbH, Hamburg (DE)

(21) Appl. No.: 18/992,492

(22) PCT Filed: Jul. 4, 2023
(86) PCT No.: PCT/EP2023/068368

§ 371 Date: Jan. 8, 2025

(30) Foreign Application Priority Data
Jul. 12, 2022 (DE) 10 2022 117 371.2

(51) Int. Cl. B29B 17/04; B29B 17/02

(52) U.S. Cl. CPC B29B 17/04; B29B 17/02; B29B 2017/0289; B29B 2017/0448; B29B 2017/0484

(57) ABSTRACT

A toothed disc cleaner includes a first cleaning tool and a second cleaning tool that face each other and a rotary drive configured to rotationally drive at least one of the first and second cleaning tools. The first and second cleaning tools each include a working surface including a plurality of cleaning teeth, and an annular working gap delimited between the working surfaces and structured for pre-cleaning the plastic waste. An inlet opens centrally into the working gap and a feed apparatus is structured to feed the plastic waste through the inlet. An outlet is structured to discharge the pre-cleaned plastic waste in the working gap. A width of the working gap narrows outward from the inlet in a first section and is kept constant in a second section arranged radially outside of the first section. The cleaning teeth of the working surfaces mesh together in a mutually spaced manner.

### CROSS-REFERENCE TO RELATED APPLICATIONS

This is a national application of PCT/EP2023/068368, filed Jul. 4, 2023, and claiming the priority and benefit, under relevant portions of 35 U.S. C. § 119, of German Patent Application No. 10 2022 117 371.2, filed on Jul. 12, 2022. The entire contents of said applications are hereby incorporated by reference.

### FIELD OF TECHNOLOGY

The following disclosure relates to embodiments of a toothed disc cleaner for pre-cleaning pre-comminuted plastic waste, in particular plastic flakes, in the course of plastic recycling. Some embodiments of the toothed disc cleaner comprise two mutually facing cleaning tools, at least one of which is driven in rotation by a rotary drive, wherein the cleaning tools each have a working surface provided with cleaning teeth. An annular working gap for pre-cleaning the plastic waste is delimited between the working surfaces lying opposite each other and the cleaning teeth of the working surfaces are positioned opposite each other and mesh together in a mutually spaced manner. Some embodiments further comprise an inlet, which opens centrally into the working gap and which comprises a feed apparatus for feeding the plastic waste to be cleaned. Some embodiments include an outlet positioned on the outer edge of the working gap and through which the plastic waste pre-cleaned in the working gap is discharged.

### BACKGROUND

Plastic waste, for example PET drinks bottles, blister packaging made of PET (deep-drawn PET films), plastic waste made of polyolefins, etc., must be cleaned in the course of recycling. Very high quality requirements must be satisfied during such cleaning processes. Permissible impurities vary within the ppm (parts-per-million) range. The presently concerned toothed disc cleaner is used to pre-clean plastic waste of this kind. Subsequently, main cleaning can take place. For the pre-cleaning, the plastic waste is first pre-comminuted, in particular into plastic shreds or else plastic flakes. The comminution can take place, for example, in a shredder (rotor with blades and counter-blades and screen basket). The desired flake size is generated by means of a hole diameter in the screen basket. The separation of metals from the plastic waste typically takes place in a pre-sorting by means of magnetic and eddy current separators. Sorting according to colors and/or types of plastic often also takes place prior to comminution of the plastic waste.

On the surfaces of plastic waste, including production waste, there is a variety of extrinsic dirt, for example adhesive labels made of paper, plastic films, or metal foils, printed-on layers of ink possibly with printed-on sealing, metallizations of the surface, adhered mud, sand, fats, oils, and various food residues. Recycling to produce high-quality polymers that are equivalent to primary plastics focuses on the almost residue-free removal of firmly adhering (extrinsic) coatings, be it with printing inks, with metallized surfaces, or with adhesion promoters (glues).

Traditional washing technologies with cold or hot process water, for example, are used for the cleaning. However, hot-melt adhesives, printing inks, and metallizations are not completely removed in the process. Complete removal should be understood to mean residual contaminations of less than 10 ppm that gives rise to only minor so-called VOCs (volatile organic components) during thermal further processing, for example extrusion or melting. In traditional caustic soda hot washes, printing inks, for example, are only removed if surfactants that are specially adapted to the caustic soda are used and if the flakes are penetrated for long periods of time in the washing lye. The removal of hot-melt adhesives is also problematic. The adhered residues in the range of at least less than 100 ppm required by the market are not generally achieved in the process. This is noticeable in the application of the recycled materials, namely due to gels in the film or a yellow tinge. Another serious consequence is outgassing during granular extrusion or during further processing in LSP (liquid state polymerization), which condenses PET in a high vacuum.

The consequences of inadequate purification that is merely “clean” as opposed to “high-purity” severely restrict the application of recycled materials and thus the marketing thereof. At the same time, requirements on the quality of the polymers are becoming stricter and are, namely, comparable with those of primary plastics. Products made of recycled materials must largely be free from color impurities, various VOCs which hamper the degassing and melt filtration in the extruder, and extrinsic contaminations, since such remaining impurities can lead to adverse changes in the polymer properties in terms of the mechanics and the processing as well as to undesired changes in the color and odor.

EP 2 094 462 B1 discloses a method for separating celluloses and other adhering substances during recycling from waste plastic, in particular mixed plastic, in which films and pieces of thicker plastic parts of potentially pre-sorted plastic waste are mechanically pre-comminuted into flakes or particles of up to a specified size and the comminuted material is introduced into a disc refiner together with water without previously generating compacted material or else an agglomerate from the flakes. Impurities are largely abraded from the flakes by the cooperating discs of the disc refiner and are subsequently present as separate substances which can be separated from the plastic parts by means of a suitable separation method. EP 2 094 461 B1 discloses a similar method.

In most cases, these known methods are sufficient for achieving satisfactory main cleaning of the plastic waste. However, the toothed disc refiner used for this is less suitable for pre-cleaning of the plastic waste, and yet pre-cleaning can be crucial to the end result of the cleaning process. Furthermore, significantly fluctuating feed consistencies of the plastic waste together with water can lead to an uneven distribution of the flakes and thus to cleaning that is not always complete.

EP 2 734 302 B1 discloses another method for removing impurities on plastic shreds using a disc refiner. The disc refiner is not a toothed disc refiner, but rather comprises, on each of the cleaning surfaces of the cleaning discs, a plurality of cleaning ribs that extend between an inner and outer edge of the cleaning surfaces, wherein multiple cleaning webs that run transversely to the extension direction of the cleaning ribs are arranged between at least some mutually adjacent cleaning ribs. At least one flank of the cleaning ribs is inclined or curved with respect to the axial direction of the relevant cleaning disc, and the cleaning webs each rise in a ramp-like manner and have a lower height than the cleaning ribs. In this way, low mechanical stress on the plastic shreds is achieved during cleaning by drawing same between the discs, in particular between the cleaning ribs, and by preventing creasing or else folding or balling of the plastic shreds, which can result in insufficient cleaning. This method is also suitable, in particular, for main cleaning of the plastic shreds.

EP 3 057 751 B1 further discloses a device and a method for cleaning plastic, in particular plastic shreds, in the course of plastic recycling. A toothed disc refiner is used which has a central inlet for feeding the plastic to be cleaned into the working gap and which has an outlet provided on the outer edge of the working gap for the cleaned plastic together with abraded impurities and water. The outlet comprises an outlet pipe through which water is pumped that flows past to the side of the working gap during operation, that is directed tangentially to the working gap, and that has a suction effect on the working gap, such that the cleaned plastic is conveyed into the outlet pipe. In this way, the discharge consistency can be flexibly set in addition to the feed and cleaning consistency, in particular regardless of the cleaning consistency. This makes it possible, in the interests of maximum energy efficiency and a maximum cleaning effect, to set a high solids consistency in the working gap and, at the same time, to set a subsequent suspension for the working gap that can be conveyed or else pumped well and that is of a low solids consistency.

The above-mentioned methods and devices are suitable, in particular, for the main cleaning of plastic waste. The methods and devices described are only suitable to a limited extent for pre-cleaning. There is also a problem with fluctuating feed consistencies, i.e. fluctuating solids contents of the plastic waste during feeding together with a process liquid, such as water, into the working gap. In such cases, this can lead to an uneven distribution of the plastic waste, which in turn can have undesired effects on the cleaning result.

Proceeding from the explained prior art, the object of the invention is therefore to provide a toothed disc cleaner for pre-cleaning pre-comminuted plastic waste that allows for reliable and complete pre-cleaning at all times.

### SUMMARY OF THE INVENTION

With regard to embodiments of a toothed disc cleaner of the type mentioned at the outset, the disclosed device solves the object in that the width of the working gap narrows radially outward starting from the inlet in a first section, and the width of the working gap is constant in a second section arranged radially outside of the first section.

As explained at the outset, the toothed disc cleaner is used to pre-clean pre-comminuted plastic waste, for example plastic flakes or else plastic shreds that have been comminuted from plastic films. In principle, the plastic flakes can be produced by means of comminution from thin-walled hard plastics or films, etc. The impurities to be removed may, in particular, be surface adhesions, for example celluloses, label residues, organic dirt, etc. The toothed disc cleaner according to the invention comprises two mutually facing cleaning tools, which may, for example, be cleaning discs. At least one of the cleaning tools is driven in rotation by a rotary drive, such that relative rotation takes place between the cleaning tools. The cleaning tools each have a working surface provided with cleaning teeth. The working surfaces are annular, in particular circularly annular, wherein an annular, in particular circularly annular, working gap is delimited between the working surfaces lying opposite each other. The cleaning teeth of the opposing working surfaces mesh together in a mutually spaced manner. The cleaning tools thus form a positive tool and a negative tool. The teeth on the working surfaces are individual teeth which are thus not interconnected by means of ribs or the like. It is possible to axially adjust the cleaning tools relative to each other by means of a corresponding adjusting apparatus, as a result of which the width of the working gap can be set. The pre-cleaning gap is formed by the spacing between the cleaning teeth, in particular the lateral flanks and crown surfaces thereof.

As explained, some embodiments of the toothed disc cleaner according to the invention is used to pre-clean the pre-comminuted plastic waste. Therefore, the focus is not on generating friction on the surfaces of the plastic waste, but rather forming a suspension of the plastic waste and the removed dirt, for example paper labels, to form separated cellulose fibers. Accordingly, there is a spacing between the meshing teeth. This spacing may be present in any possible axial position, i.e. also in the case of the smallest settable width of the working gap, such that the teeth of the opposing cleaning tools, in particular the tooth flanks thereof, never come into direct contact. It is conceivable for the cleaning tools to be settable in such a way that, for example, the crown surfaces of the cleaning teeth come into contact with the base of the opposing cleaning tool, but not the lateral flanks of the cleaning teeth. As a result, the plastic waste to be pre-cleaned is forced over the tooth flanks, which can improve the pre-cleaning result. The axis of rotation of the at least one rotatably driven cleaning tool, in particular of the cleaning disc, may simultaneously be the axis of symmetry of the cleaning tool, in particular of the cleaning disc. An electric drive, for example, is an option as the rotary drive.

In some embodiments, the toothed disc cleaner further comprises an inlet which opens centrally into the working gap, in an embodiment of the cleaning tools as cleaning discs in particular in the axial direction of the cleaning discs, which axial direction simultaneously forms the axis of rotation. A feed apparatus is provided for feeding the plastic waste to be cleaned into the working gap via the inlet. The feed apparatus may supply the plastic waste together with a process liquid, such as water, into the working gap. A corresponding liquid supply apparatus may be provided for this purpose. However, separate supplying of the process liquid, for example water, into the working gap via a separate liquid supply apparatus is also possible.

After being fed into the working gap, the plastic waste is pre-cleaned in the working gap between the mutually opposing working surfaces. In the process, the plastic waste, for example plastic flakes, is sheared between the cleaning tools and, in this way, is distributed in a uniform manner in the working gap. In the process, the plastic waste passes the rows of teeth formed of the cleaning teeth, wherein further shearing open of, for example, film packets or fibers, such as ropes, as well as the formation of a suspension of organic adherents occurs. For example, printing inks or metallized surfaces are not or are only slightly removed in the course of the pre-cleaning, whereas celluloses or the like are. In the course of the cleaning process, the plastic waste is transported radially outward starting from the central inlet in the working gap and arrives at the outlet provided at the outer edge of the working gap, via which outlet the plastic waste is discharged together with the removed organic adherents and the process liquid for further processing, in particular main cleaning.

According to some embodiments, it is provided that the width of the working gap narrows radially outward starting from the central inlet in a first section, and the width of the working gap is constant in a second section arranged radially outside of the first section. The first section and the second section may, in particular, be a first annular section and a second annular section. The inflow zone formed by the first section is used to receive the material quantity of plastic waste at the inlet. On account of the initially wider and then outwardly narrowing working gap in the first section, homogenization and uniform distribution of the plastic waste occurs, even if the feed consistency, i.e. the content of plastic waste, fluctuates significantly per unit of time and/or by volume of process liquid. This homogenization and uniform distribution is crucial for the subsequent cleaning success. Optimal cleaning can only be achieved if the plastic waste is transported as uniformly and separated as possible along the rows of teeth formed by the opposing cleaning teeth outward to the outlet.

The second section, in which the working gap width is constant, is also crucially important here. Only the combination of the narrowing first section and the constant second section yields the optimal cleaning result, in that the required homogenization and equalization of the plastic waste takes place in the first section and sufficient physical loading of the plastic waste for an optimal cleaning effect is achieved in the second section with an unchanging working gap width. Thus the plastic waste, in particular the plastic flakes, becomes oriented in parallel with the flanks of the cleaning teeth in the inflow zone formed by the first section, wherein accumulation or clumping of plastic waste, which would be prejudicial to the cleaning, is prevented. In the working zone formed by the second section, the required processing of the plastic waste for the pre-cleaning takes place.

In particular, plastic flakes created from plastic films are difficult to dose for cleaning, since they have a high dry and wet volume at a low bulk density. On account of the design according to the invention of the working gap with the first section and the inflow zone formed thereby, the cleaning tools can also receive, for example, sinusoidally fluctuating doses without a problem, for example without becoming clogged. On account of the design according to the invention of the working gap, sandwiched or film packets created in the course of the comminution of plastic films are also reliably disintegrated.

In the course of the pre-cleaning, organic adherents or else celluloses, in particular, are removed from the plastic waste without the plastic waste being destroyed to a significant extent, which could significantly hamper subsequent separation of the suspension constituents and main cleaning. The pre-comminution of the plastic waste is particularly important in that the pre-comminuted plastic waste can be lengthened on account of the unfolding, by the cleaning tools according to the invention, of plastic flakes that are folded together in a concertina-like manner as well as on account of the disintegration of film packets into individual flakes. In practice, a medium grain size of the pre-comminuted plastic waste of no more than 50 mm, for example, has proven expedient. For example, flake sizes of no more than twice the height of the cleaning teeth may be suitable. By means of the toothed disc cleaner according to the invention, a cleaning result of the plastic waste with less than 200 ppm of extrinsic residual contaminations is already possible in the course of the pre-cleaning. Then, by means of subsequent main cleaning, the currently required high purities of the recycled materials can be reliably achieved.

As explained, a process liquid, such as water, is typically also supplied to the working gap. On account of the design according to the invention of the toothed disc cleaner, significantly lower process liquid temperatures as well as a drastic reduction in the use of NaOH or surfactant admixtures are possible compared with the prior art.

According to some embodiments, the second section may directly follow on from the first section. In this way, the transition between the inflow zone formed by the first section and the working zone formed by the second section is optimized.

According to a further embodiments, the second section may extend up to the outer edge of the working gap. The first section and the second section together may cover the entire working gap. However, it is also conceivable, for example, for an inlet portion on which, for example, no cleaning teeth are arranged to be provided between the inlet and the first section.

In some embodiments, the working surfaces of the cleaning tools comprising the cleaning teeth may be arranged in a cone shape in the first section and in parallel with each other in the second section. In this way, the first and second section can be designed in a particularly simple manner.

According to some embodiments, the cleaning teeth may be arranged on the surface sections of the working surfaces of the cleaning tools that form the first section in each case at a greater distance from each other than on the surface sections of the working surfaces of the cleaning tools that form the second section. The density of cleaning teeth per unit of area is thus lower in the first section than in the second section. As a result, the inflow of the plastic waste is further facilitated and the homogenization and equalization as well as separation of the plastic waste is further improved, while particularly effective pre-cleaning takes place in the working zone formed by the second section on account of the cleaning teeth arranged closer together.

In a side view, the cleaning teeth of the cleaning tools may in each case have the shape of a shark fin. Furthermore, it can be provided that a flank of the cleaning teeth of the cleaning tools that is leading in the course of the relative rotation of the cleaning tools is arranged at an angle of between 30°and 60°with respect to the working surface in each case bearing the cleaning teeth. It can also be provided that a flank of the cleaning teeth of the cleaning tools that is trailing in the course of the relative rotation of the cleaning tools is arranged at an angle of between 70°and 90°with respect to the working surface in each case bearing the cleaning teeth. When reference is made to a “leading” or “trailing” flank, this relates to the relative rotation of the cleaning tools, and therefore, for example, a cleaning tool that is not driven in rotation (stator) also comprises leading and trailing flanks on account of the relative rotation with respect to an opposing cleaning tool that is driven in rotation (rotor). The angle to the working surface is measured in each case in the shortest direction. On account of this design of the cleaning teeth, in particular the flatter obliquity of the leading tooth flanks, particularly effective pre-cleaning is made possible with simultaneously optimized energy consumption of the toothed disc cleaner. Thus the oblique design advantageously leads to prolonged surface contact of the flexible plastic waste, in particular plastic flakes, which are oriented in parallel in particular in the second section, i.e. the working zone, and thus leads to effective pre-cleaning. In this way, it is also possible to generate a targeted pump effect that effectively transports the plastic waste from the inlet through the working gap to the outlet, in particular to convey the plastic waste outward sequentially from tooth ring to tooth ring. The cleaning teeth that move through the suspension of plastic waste and cleaning liquid generate a flow due to their shape. On account of the oblique design of the above-mentioned tooth flanks, a targeted pump effect can be produced. The energy demand of the toothed disc cleaner can also be reduced on account of an optimal hydrodynamic design of the tooth flanks.

According to some embodiments, at least one radially outer lateral flank of the cleaning teeth may be configured obliquely with respect to the working surface in each case bearing the cleaning teeth. Furthermore, mutually opposing lateral flanks of meshing cleaning teeth may be mutually spaced in parallel. Accordingly, the relevant opposing, i.e. radially inner, lateral flank of the cleaning teeth may be oblique with respect to the working surface. The lateral flanks of a cleaning tooth may, for example, be mirror-symmetrical with respect to each other, in particular in at least one rotary position of the cleaning tools with respect to each other. The oblique arrangement may, for example, be at an angle of between 10°and 30°with respect to the relevant working surface, again measured in the shortest direction. The cleaning teeth of a cleaning tool may have the same height. This applies, accordingly, to both cleaning tools, wherein the cleaning teeth of both cleaning tools may also have the same height. The cleaning teeth form a line, such that plastic waste, in particular plastic flakes, can be oriented in parallel with the lateral flanks of the cleaning teeth. On account of the above-mentioned design of the lateral flanks of the cleaning teeth, firstly, the pump effect can be improved further and, secondly, the cleaning effect can thus be optimized further.

At least one of the edges between leading or else trailing flanks and lateral flanks and/or at least one of the edges between leading or else trailing flanks and/or lateral flanks and a crown surface of the cleaning teeth may be rounded. The above-mentioned advantageous effects are further enhanced by reducing friction that is not primarily desirable, in particular during the pre-cleaning.

According to further embodiments, the cleaning tools may be stainless steel cast parts. Stainless steel casting, for example based on an alloy with a high Brinell hardness, produces a comparatively rough surface, inter alia, for the cleaning teeth for process-related reasons. In stainless steel casting, in particular, the hardness of the surface is so high that mechanical loading by the plastic waste does not lead to a loss of the roughness. Thus it is ensured over long periods of time that the cleaning teeth can perform their cleaning function.

As explained, at least one of the cleaning tools, preferably both cleaning tools, may be a cleaning disc. The cleaning disc may, for example, be designed circularly annularly. It may, for example, be constructed from multiple circular ring segments. The axial direction then also forms the direction of rotation of the at least one cleaning disc. The inlet may then open into the working gap in the axial direction of the at least one cleaning disc.

According to some embodiments, it can be provided that the feed apparatus comprises a liquid supply apparatus by means of which a liquid can be supplied directly into the feed apparatus and/or that the working gap is assigned a liquid supply apparatus by means of which a liquid can be supplied directly into the working gap. The feed apparatus may, for example, comprise a screw conveyor that conveys the plastic waste to the inlet. A process liquid, such as water, can be fed directly into the feed apparatus, for example into the flight of a screw conveyor, by means of a liquid supply apparatus of the feed apparatus, in particular via suitable nozzles. As explained, however, it would also be conceivable for the working gap to be assigned a liquid supply apparatus by means of which liquid can be supplied directly into the working gap. For example, a screw conveyor could be designed as a hollow shaft auger and process liquid, such as water, could be fed directly into the working gap via the hollow shaft. Of course, other feeding possibilities for the process liquid, in particular other nozzles for direct introduction into the working gap, are possible as an alternative or in addition.

The invention also solves the object by means of the use of a toothed disc cleaner according to the invention for pre-cleaning plastic flakes that have been pre-comminuted from plastic films. The toothed disc cleaner according to the invention is particularly suitable for pre-cleaning plastic flakes that have been pre-comminuted from plastic films. Cleaning results of less than 200 ppm of extrinsic residual contamination can already be achieved with the pre-cleaning. It is important here to maintain suitable solids consistencies in the working gap, for example of less than 5 wt. % in the case of plastic flakes that have been pre-comminuted from plastic films. In the case of PET or else hard plastics in material transportation, the solids consistency may be selected to be somewhat higher, for example no more than 10 wt. %. It is also important to immediately drain off the process liquid such that re-contamination due to the cleaned plastic waste dwelling for too long is prevented. As explained, in the use according to the invention of a toothed disc cleaner according to the invention, grain sizes of the pre-comminuted plastic waste of no more than 50 mm have proven practicable.

### BRIEF DESCRIPTION OF THE DRAWINGS

One exemplary embodiment of the invention is explained below in greater detail using figures.

FIG. 1 schematically illustrates a perspective view of an embodiment of a cleaning disc of a toothed disc cleaner.

FIG. 2 schematically illustrates a plan view of the embodiment of the cleaning disc from FIG. 1.

FIG. 3 schematically illustrates a sectional view along an embodiment of a toothed disc cleaner.

FIG. 4 schematically illustrates two views of an embodiment of the cleaning disc of the toothed disc cleaner.

FIG. 5 schematically illustrates a partial sectional view of an embodiment of a toothed disc cleaner.

FIG. 6 schematically illustrates the embodiment of the toothed disc cleaner according to FIG. 5 with an embodiment of a feed apparatus for feeding plastic waste to be cleaned.

FIG. 7 schematically illustrates the embodiment of the toothed disc cleaner according to FIG. 5 with an embodiment of a feed apparatus for feeding plastic waste to be cleaned.

FIG. 8 schematically illustrates the embodiment of the toothed disc cleaner according to FIG. 5 with an embodiment of a feed apparatus for feeding plastic waste to be cleaned.

FIG. 9 schematically illustrates a sectional view of an embodiment of a toothed disc cleaner with an embodiment of an outlet.

If not otherwise specified, the same reference signs denote the same objects in the figures.

### DETAILED DESCRIPTION OF THE INVENTION

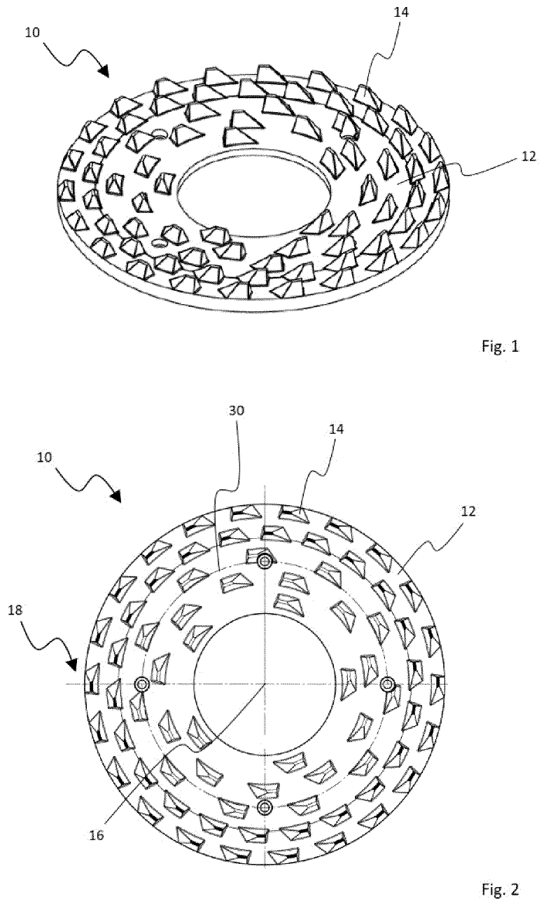

In FIGS. 1 and 2, a cleaning tool 10 of a toothed disc cleaner according to some embodiments of the invention is represented, in the present case a circularly annular cleaning disc 10 which may, for example, also be constructed from multiple circular ring segments. The cleaning disc 10 comprises a circularly annular working surface 12 on which a large number of cleaning teeth 14 are arranged. At the center, the cleaning disc 10 forms an inlet 16 for plastic waste to be pre-cleaned, for example plastic flakes from pre-comminuted plastic films. An outlet 18 for the pre-cleaned plastic waste is formed on the outer edge of the cleaning disc 10. A feed apparatus for feeding the plastic waste to be cleaned is connected to the inlet. The plastic waste may be fed, for example, together with a process liquid, such as water.

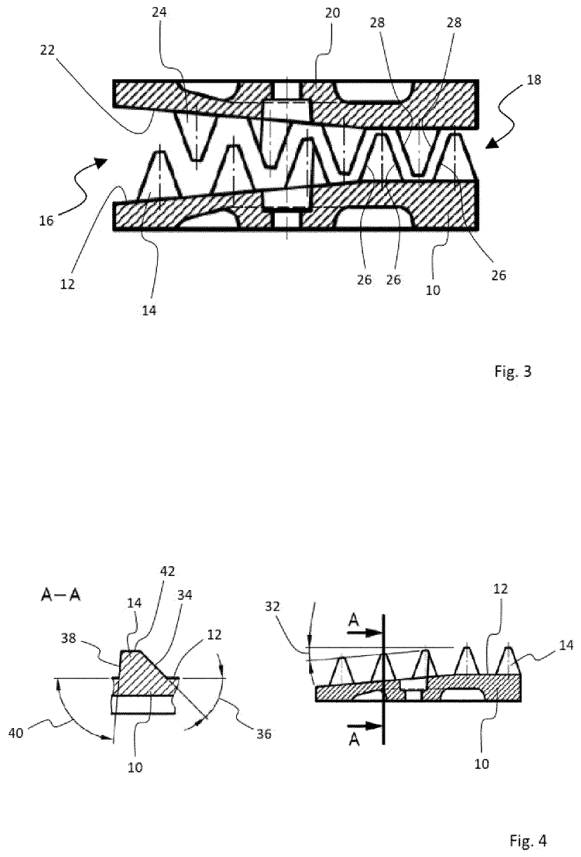

In FIG. 3, the cleaning disc 10 shown in FIGS. 1 and 2 is represented as a lower cleaning disc 10 together with an upper cleaning tool 20, in the present case an upper cleaning disc 20. The upper cleaning disc 20 is also configured circularly annularly and comprises a circularly annular working surface 22. Again, there are a large number of cleaning teeth 24 on the working surface 22 of the upper cleaning disc 20. At least one of the cleaning discs 10, 20 can be driven in rotation about the axis thereof by means of a rotary drive, such that a corresponding relative rotation between the cleaning discs 10, 20 is produced. The upper cleaning disc 20 is largely identical to the lower cleaning disc 10, with the difference that the rows of teeth formed from the cleaning teeth 24 are in each case radially offset with respect to the rows of teeth of the lower cleaning disc 10 formed from the cleaning teeth 14, such that the cleaning teeth 14 and 24 mesh together in a mutually spaced manner, as shown in FIG. 3. FIG. 3 also shows that mutually opposing lateral flanks 26, 28 of the meshing cleaning teeth 14, 24 are mutually spaced in parallel. It can also be seen that the lateral flanks 26 of the cleaning teeth 14 and the lateral flanks 28 of the cleaning teeth 24 are in each case designed mirror-symmetrically and are arranged obliquely, for example at an angle of between 10°and 30°, with respect to the working surface 12 and 22 bearing the cleaning teeth 14 and 24, respectively.

It is also particularly clear from FIG. 3 that the working surfaces 12 and 22 of the cleaning discs 10 and 20, in a first section, extend radially outward conically relative to each other starting from the inlet 16, such that the working gap formed between the working surfaces 12, 22 narrow radially outward starting from the inlet 16 in this first section. In a second section following on from the first section and continuing up to the outlet 18, the working surfaces 12 and 22 of the cleaning discs 10 and 20 are arranged in parallel with each other, such that the width of the working gap in this second section is constant. In FIG. 2, for illustrative purposes, the circular separation line between the radially inner first section in FIG. 2 and the radially outer second section is drawn in at the reference sign 30. It can also be seen in FIGS. 1 and 2 that the cleaning teeth 14 on the surface section of the working surface 12 forming the first section are arranged at a greater distance from each other than in the outer surface section of the working surface 12 forming the second section. The tooth density of cleaning teeth 14 is thus lower in the first section than in the second section. This is also the case for the upper cleaning disc 20.

The configuration of the toothed disc cleaner according to the invention shall be explained in more detail based on FIG. 4. Firstly, the cone angle 32 of the conical arrangement of the working surfaces 12 and 22 in the first section is represented in the right-hand view of FIG. 4, in which only the lower cleaning disc 10 is represented in section. The left-hand view in FIG. 4 is a sectional representation along the line A-A in the right-hand view of FIG. 4. In particular, one of the cleaning teeth 14 is shown there in a sectional view, wherein the direction of rotation of the cleaning disc 10 extends from left to right in the left-hand representation of FIG. 4. A flank 34 of the cleaning tooth 14 that is leading in the course of the relative rotation between the cleaning discs 10, 20 is arranged at an angle 36 of between 30°and 60°, in the present case approximately 45°, with respect to the working surface 12. A flank 38 of the cleaning tooth 14 that is trailing in the course of the relative rotation between the cleaning discs 10, 20 is arranged at an angle 40 of between 80°and 90°, in the present case approximately 85°, with respect to the working surface 12. The crown surface 42 of the cleaning tooth 14 may be in parallel with the working surface 12.

In some embodiments, edges between the various surfaces of the cleaning tooth 14, in particular the leading and trailing flanks 34, 38 and the crown surface 42 and/or between the leading and trailing flanks 34, 38 and the lateral flanks 26 and/or between the lateral flanks 26 and the crown surface 42 may be rounded. All cleaning teeth 14 and 24 may be designed as represented in FIG. 4 by way of example for one of the cleaning teeth 14. In some embodiments, the cleaning discs 10, 20 can, in each case, be produced as a stainless steel cast part.

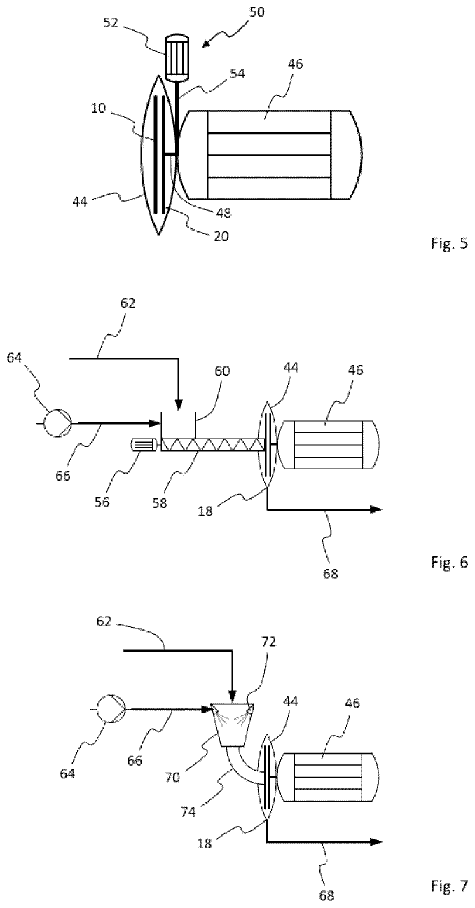

In FIG. 5, cleaning discs 10, 20, which may, for example, be configured as explained with reference to FIG. 1 to 4, are arranged in a cleaner housing 44 so as to be rotatable relative to each other. During operation, a rotary drive 46 may, for example, drive the cleaning disc 20 in rotation about a rotary shaft 48, such that the cleaning discs 10, 20 perform a rotation relative to each other. The working gap between the cleaning discs 10, 20 can be set via an adjusting apparatus 50 comprising an adjusting drive 52 and an adjusting element 54.

Various possibilities for feeding plastic waste to be pre-cleaned into the toothed disc cleaner will be explained based on FIGS. 6 to 8. In FIG. 6, the feed system comprises a feed screw 58 which is driven via a worm drive 56 and to which plastic waste 62 to be pre-cleaned is supplied on one side via an inlet opening 60 and to which a cleaning liquid 66, such as water, is supplied on the other side by means of a pump 64. The cleaning liquid can, in principle, be added via a screw feed, also via multiple inlets, into the feed screw 58 downstream of the inlet, via a hollow shaft of the feed screw 58 and/or via feed nozzles in the cleaner housing 44. The feed screw 58 conveys the plastic waste 62 together with the cleaning liquid 66 centrally into the working gap formed between the cleaning discs 10, 20. The pre-cleaned plastic waste is discharged for further processing via the outlet 18, as represented in FIG. 6 at the reference sign 68.

The exemplary embodiment according to FIG. 7 differs from the exemplary embodiment according to FIG. 6 merely in that, instead of the feed screw 58, a feed hopper 70 is provided which comprises, on the upper edge thereof, multiple feed nozzles 72 arranged, for example, so as to be distributed at regular intervals. Cleaning liquid 66 supplied by the pump 64 is fed into the feed hopper 70 via the feed nozzles 72, for example in each case as a liquid jet onto an inner wall of the feed hopper 70, in which the supplied plastic waste 62 is located. The plastic waste 62 together with the cleaning liquid 66 is supplied via a connection 74 again centrally into the working gap between the cleaning discs 10, 20. Such a feed apparatus is known, for example, from EP3 423 203 B1.

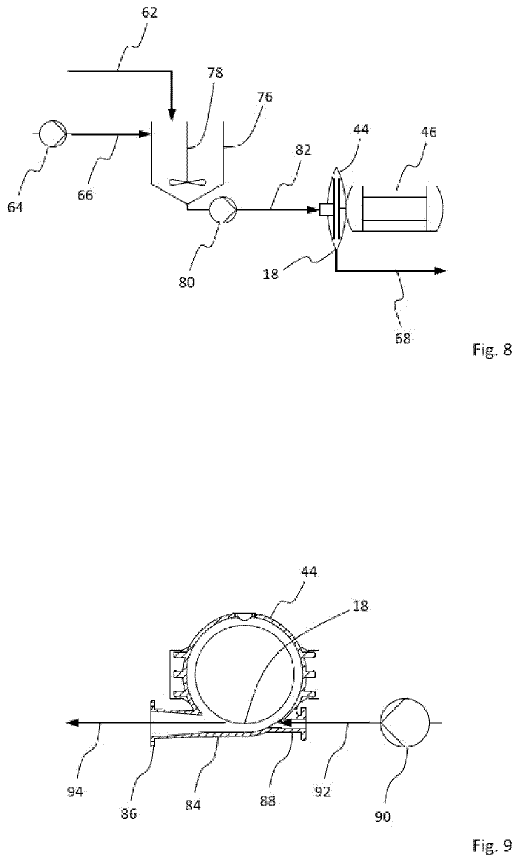

In the exemplary embodiment according to FIG. 8, a feed tank 76 with a stirring apparatus 78 arranged therein is provided, into which the plastic waste 62 and the cleaning liquid 66 are supplied. The plastic waste 62 is stirred with the cleaning liquid 66 in the feed tank 76. The plastic waste 62 mixed with the cleaning liquid 66 is supplied via a pump 80 again centrally into the working gap between the cleaning discs 10, 20, as illustrated in FIG. 8 at 82.

By way of example, FIG. 9 shows an outlet of a toothed disc cleaner according to the invention, wherein only the cleaner housing 44 of the toothed disc cleaner is represented in section with the outlet in FIG. 9. The design represented in FIG. 9 corresponds, for example, to the design described in EP 3 057 751 B1. The exemplary embodiment according to FIG. 9 can be combined with any of the above-explained exemplary embodiments.

In the example represented, an outlet pipe 84 follows on from the outlet 18 of the toothed disc cleaner tangentially with respect to the working gap between the cleaning discs 10, 20. The outlet pipe 84 may be connected directly via a flange 86 or via a further pipe to a separating apparatus, in which the pre-cleaned plastic is separated from the impurities abraded in the working gap. In the example shown, at the end of the outlet pipe 84 that is remote from the flange 86 or else separating apparatus, a nozzle pipe 88 is connected to a pump 90, in particular a liquid pump 90, for example a water pump 90, such as a centrifugal pump.

During operation of the toothed disc cleaner, the plastic pre-cleaned in the working gap enters the outlet pipe 84 via the outlet 18 together with abraded impurities and the cleaning liquid on account of a centrifugal force. At the same time, liquid, such as water, is fed by means of the liquid pump 90 through the nozzle pipe 88, in the conveying direction of the suspension coming out of the working gap to the separating apparatus, and into the outlet pipe 84 in the form of a directed liquid jet, as illustrated in FIG. 9 at the reference sign 92. The directed liquid jet thus extends tangentially to the working gap, like the outlet pipe 84. The liquid jet transports the mixture of cleaning liquid and pre-cleaned plastic as well as abraded impurities in the outlet pipe 84 further to the separating apparatus, as illustrated in FIG. 9 at the reference sign 94. In the process, the liquid jet exerts a suction effect on the working gap as per the principle of a jet pump, such that the suspension of pre-cleaned plastic, abraded impurities, and cleaning liquid is sucked out of the working gap and into the outlet pipe 84. At the same time, the discharge consistency, i.e. the consistency in the outlet pipe 84, can be set in a suitable manner by means of the liquid jet. A solids pump is therefore not required, nor is a pump sump.

### LIST OF REFERENCE SIGNS

10 Cleaning disc
12 Working surface
14 Cleaning teeth
16 Inlet
18 Outlet
20 Cleaning disc
22 Working surface
24 Cleaning teeth
26 Lateral flanks
28 Lateral flanks
30 Separating line
32 Cone angle
34 Leading flank
36 Angle
38 Trailing flank
40 Angle
42 Crown surface
44 Cleaner housing
46 Rotary drive
48 Rotary shaft
50 Adjusting apparatus
52 Adjusting drive
54 Adjusting element
56 Worm drive
58 Feed screw
60 Inlet opening
62 Plastic waste
64 Pump
66 Cleaning liquid
68 Arrow
70 Feed hopper
72 Feed nozzles
74 Connection
76 Feed tank
78 Stirring apparatus
80 Pump
82 Arrow
84 Outlet pipe
86 Flange
88 Nozzle pipe
90 Pump
92 Arrow
94 Arrow

1-14. (canceled)

15. A toothed disc cleaner for pre-cleaning pre-comminuted plastic waste, during a process of plastic recycling, comprising:
a first cleaning tool and a second cleaning tool, wherein the first and second cleaning tools face each other;
a rotary drive configured to rotationally drive at least one of the first and second cleaning tools;
wherein the first and second cleaning tools are each structured to comprise:
a working surface including a plurality of cleaning teeth, and
an annular working gap delimited between the working surfaces of the first and second cleaning tools and configured for pre-cleaning the plastic waste;
an inlet configured to opens centrally into the working gap;
a feed apparatus configured to feed the plastic waste to be cleaned through the inlet; and
an outlet provided on an outer edge of the working gap configured to discharge the pre-cleaned plastic waste in the working gap,
wherein a width of the working gap narrows radially outward starting from the inlet in a first section,
wherein the width of the working gap is constant in a second section arranged radially outside of the first section, and
wherein the cleaning teeth of the working surfaces of the first and second cleaning tools mesh together in a mutually spaced manner.

16. The toothed disc cleaner according to claim 15, wherein the second section directly follows from the first section.

17. The toothed disc cleaner according to claim 15, wherein the second section extends to an outer edge of the working gap.

18. The toothed disc cleaner according to claim 15, wherein the working surfaces of the first and second cleaning tools comprise a cone shape in the first section and parallel surfaces in the second section.

19. The toothed disc cleaner according to claim 15, wherein the plurality of cleaning teeth are arranged on the first and second sections of the working surfaces of the first and second cleaning tools that form the first section at a greater distance from each other than on the surface sections of the working surfaces of the first and second cleaning tools that form the second section.

20. The toothed disc cleaner according claim 15, wherein each of the plurality of cleaning teeth comprises a flank in a direction of rotation and that comprises an angle of between 30°and 60°relative to a respective working surface.

21. The toothed disc cleaner according to claim 15, wherein each of the plurality of cleaning teeth comprises a flank in a direction opposite to a direction of rotation and arranged at an angle of between 70°and 90°relative to a respective working surface.

22. The toothed disc cleaner according to claim 15, wherein at least one radially outer lateral flank of the plurality of cleaning teeth is configured obliquely with respect to a respective working surface.

23. The toothed disc cleaner according to claim 22, wherein mutually opposing lateral flanks of meshing cleaning teeth are mutually spaced in parallel.

24. The toothed disc cleaner according to claim 15, wherein the first and second cleaning tools are comprised of stainless steel cast parts.

25. The toothed disc cleaner according to claim 15, wherein at least one of the first and second cleaning tools comprises a cleaning disc.

26. The toothed disc cleaner according to claim 25, wherein the inlet opens into the working gap in an axial direction of the at least one cleaning disc.

27. The toothed disc cleaner according to claim 15, wherein the feed apparatus comprises a liquid supply apparatus configured to feed a liquid directly into the feed apparatus.

28. The toothed disc cleaner according to claim 15, further comprising a liquid supply apparatus configured to supply a liquid directly into the working gap.
